(19) United States
(12) Patent Application Publication
(10) Pub. No.: US 2007/0198326 A1
(43) Pub. Date: Aug. 23, 2007

(54) Process of using real estate MLS sales statistics to create a benchmark for sales requirements in specific areas of a country, state, or city to qualify real estate agents and brokers from other companies (brokerages) to market themselves on a website of a licensed third party real estate broker

(76) Inventor: Leviticus Johnson, Alpharetta, GA (US)

Correspondence Address: FURR LAW FIRM, 2622 DEBOLT ROAD, UTICA, OH, 43080, US

(21) Appl. No.: 11/669,146

(22) Filed: Jan. 30, 2007

Related U.S. Application Data
(60) Provisional application No. 60/763,517, filed on Jan. 30, 2006.

(51) Int. Cl. G07G 1/00; G06F 17/30

(52) U.S. Cl. 705/10

(57) ABSTRACT

Process of using real estate MLS sales statistics to create a benchmark for sales requirements in specific areas of a state of city, to qualify real estate agents and brokers from other companies (brokerages) to market themselves on a website of a licensed third party real estate broker while not being affiliated in a traditional agent broker relationship.

### CROSS-REFERENCES TO RELATED APPLICATIONS (IF ANY)

None

### STATEMENT AS TO RIGHTS TO INVENTIONS MADE UNDER FEDERALLY-SPONSORED RESEARCH AND DEVELOPMENT (IF ANY)

None

### BACKGROUND OF INVENTION

1. Field of the Invention

This invention relates to a method of marketing real estate agents and brokers online.

2. Background

Real estate agents and brokers commonly supply consumers with real estate information online through the use of a web site. Such web sites are also used by real estate buyers and sellers with current property information including listings of properties for sale.

Originally these sites were created for agents who could afford the high cost of creating and maintaining a web site. However, consumers had no way to verify the experience of agents represented on these sites

Thereafter, various types of web sites were designed for real estate agents to advertise themselves, and their listings to consumers.

U.S. Pat. No. 6,760,707 discloses a web site which enables sellers to create individualized web sites for individual properties for sale. This concept is designed as a “way sellers and buyers can find each other to effect a mutually beneficial transaction,” eliminating the expertise of a licensed real estate agent.

U.S. Pat. No. 6,684,196 to Mini, et al. on Jan. 27, 2004 describes a process which again, eliminates the expertise of a licensed real estate agent by connecting buyers directly with sellers. Thus if the buyer or seller has limited real estate expertise, and/or is concerned with his knowledge of the local real estate market, this process is useless. Also, being relatively narrow and clumsy, the process is susceptible to a situation where legalities of a contract are in question, such situations can become an encumbrance to either party.

Although a process without a licensed real estate agent is simple to initiate and inexpensive, it does not damage a time frame upon being conducted, and can be used repeatedly, nevertheless it simply does not possess the knowledge of a uniform contract by law, created by an experienced licensed real estate agent. Finally, Mini's process consists of each step of a real estate transaction, but lacks the support of other professionals such as a lender and an escrow agent which are essential in order to bring a transaction to a close.

Several types of computerized closing methods have been proposed—for example, in U.S. Pat. Nos. 7,085,735, 6,684,196, 6,760,707,

There exists a need to get better results. There is still room for improvement in the art.

### SUMMARY OF THE INVENTION

The current invention is a process of using real estate MLS sales statistics to create a benchmark for sales requirements in specific areas of a state of city, to qualify real estate agents and brokers from other companies (brokerages) to market themselves on a website of a licensed third party real estate broker while not being affiliated in a traditional agent broker relationship.

### GLOSSARY OF TERMS

Browser: a software program that runs on a client host and is used to request Web pages and other data from server hosts. This data can be downloaded to the client's disk or displayed on the screen by the browser.
Client host: a computer that requests Web pages from server hosts, and generally communicates through a browser program.
Content provider: a person responsible for providing the information that makes up a collection of Web pages.
Embedded client software programs: software programs that comprise part of a Web site and that get downloaded into, and executed by, the browser.

### Cookies: data blocks that are transmitted to a client browser by a web site.

### Hit: the event of a browser requesting a single Web component.

Host: a computer that is connected to a network such as the Internet. Every host has a hostname (e.g., mypc.mycompany.com) and a numeric IP address (e.g., 123.104.35.12).
HTML (HyperText Markup Language): the language used to author Web Pages. In its raw form, HTML looks like normal text, interspersed with formatting commands. A browser's primary function is to read and render HTML.

### HTTP (HyperText Transfer Protocol): protocol used between a browser and a Web server to exchange Web pages and other data over the Internet.

### HyperText: text annotated with links to other Web pages (e.g., HTML).

### IP (Internet Protocol): the communication protocol governing the Internet.

Server host: a computer on the Internet that hands out Web pages through a Web server program.
URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.
UWU server: in connection with the present invention, a special Web server in charge of distributing statistics describing Web traffic.

### Visit: a series of requests to a fixed Web server by a single person (through a browser), occurring contiguously in time.

Web master: the (typically, technically trained) person in charge of keeping a host server and Web server program running.
Web page: multimedia information on a Web site. A Web page is typically an HTML document comprising other Web components, such as images.
Web server: a software program running on a server host, for handing out Web pages.
Web site: a collection of Web pages residing on one or multiple server hosts and accessible through the same hostname (such as, for example, www.lucent.com).

### BRIEF DESCRIPTION OF THE DRAWINGS

Without restricting the full scope of this invention, the preferred form of this invention is illustrated in the following drawings:

FIG. 1 shows an overview of how a User accesses the system;

FIG. 2 displays a log in screen;

FIG. 3 displays a marketing subdivision shown in map form;

FIG. 4 displays a marketing radius;

FIG. 5 displays an agent's registration process; and

FIG. 6 displays a non-agent's registration process.

### BRIEF DESCRIPTION OF THE PREFERRED EMBODIMENTS

There are a number of significant design features and improvements incorporated within the invention.

The present invention relates to system 1 and a process that uses actual sales statistics taken from a local or regional MLS to create a benchmark for sales requirements of licensed real estate agents in a specific area of a state or city. Said agents are licensed under another broker and even with verifiable guidelines for qualification, nevertheless all online processes heretofore known suffer from a number of disadvantages such as their manufacture requires the use of multiple real estate legalities in multiple states and regions, which requires adaptation to various laws.

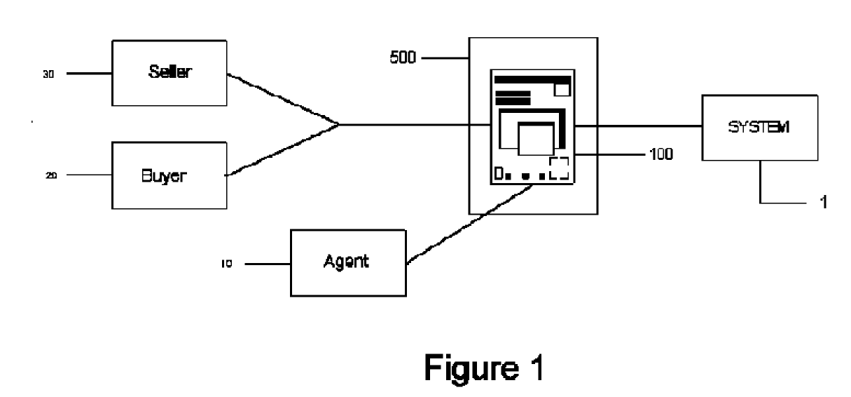

FIG. 1 illustrates a functional diagram of a computer network for World Wide Web 500 access to the System 1 from a plurality of Agents 10, Buyers 20 and Sellers 30 who accesses the system Web Site 100 or they can connect directly to the System 1. Accessing the System Web Site 100 can be accomplished directly through a communication means such as a direct connection, an intranet, a local Internet Service Provider, often referred to as ISPs, or through an on-line service provider like CompuServe, Prodigy, American Online, etc. or Wireless devices using services like AT&T or Verizon. Each user 10 will have a display device such as a monitor and an input device like a keyboard. This display and input device can even be a PDA like a blackberry.

The Agents 10, Buyers 20 and Sellers 30 contact the System Web Site 100 using an informational processing system (Client) capable of running an HTML compliant Web browser such as Microsoft's Internet Explorer, Netscape Navigator, Lynx, Safari, and Mosaic. A typical system that is used is a personal computer with an operating system such as Windows 95, 98 or ME, NT, 2000, MacIntosh, or Linux, running a Web browser. The exact hardware configuration of computer used by the Users 10, the brand of operating system or the brand of Web browser configuration is unimportant to understand this present invention. Those skilled in the art can conclude that any HTML (Hyper Text Markup Language) compatible Web browser is within the true spirit of this invention and the scope of the claims. The Agents 10, Buyers 20 and Sellers 30 can also access the system 1 through voice and E-mail, as well as any other standard or new form of communication.

In one preferred embodiment of the invention, the Agents 10, Buyers 20 and Sellers 30 connect to the System 1. The Agents 10, Buyers 20 and Sellers 30 will typically be a real estate investor. The system 1 will have a database 310 for the storing of data and code.

The system 1 will enable different modes of input devices for interaction such as keyboard, touch-screen, fax, audio, cellphones, pda, etc. and will output information on appropriate displays such as video terminals, e-mail, fax, audio, cellphones etc.

Output can include a screen, a graphical user interface, hardcopy, facsimile, e-mail, messaging or other communication with any humanly or machine discernable data and/or artifacts. In some embodiments, output can include transmitting the risk variable related data to a designated recipient, any humanly or machine discernable data and/or artifacts.

The data processing system 1 for both embodiments includes computer processing means for processing data, storage means for storing data on a storage medium, and communication means for transferring data in a secure environment.

The system 1 will use actual sales statistics from an MLS to create benchmarks, which agents must meet or exceed in order to qualify to be marketed on the site. For example the system 1 could use 1% of sales in the country, city, state or area during the previous year. These sales would be verified through MLS sales history.

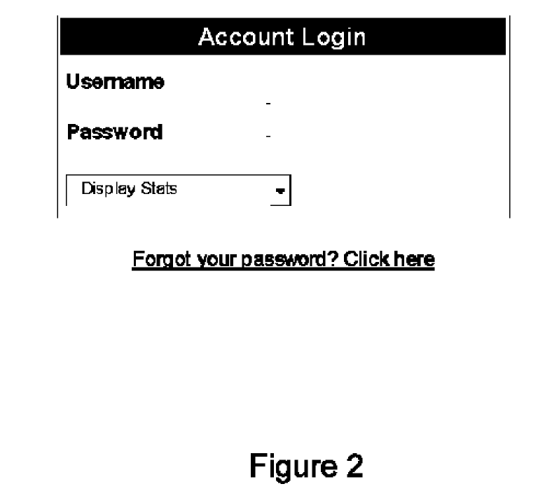

The system 1 will have the Buyers 20 and sellers 30 registrations and login using a login screen similar to FIG. 2. This will allow confidential interaction with agents 10. The system 1 would have a standard logon web page as shown in FIG. 2. There would be a data entry field for Username and Password. The Username would have to be unique and the password would have to be at least eight characters. The web page will have a mechanism for Buyers 20 and sellers 30 who forget their password. This technology is well know in the art and therefor is not covered in great detail here.

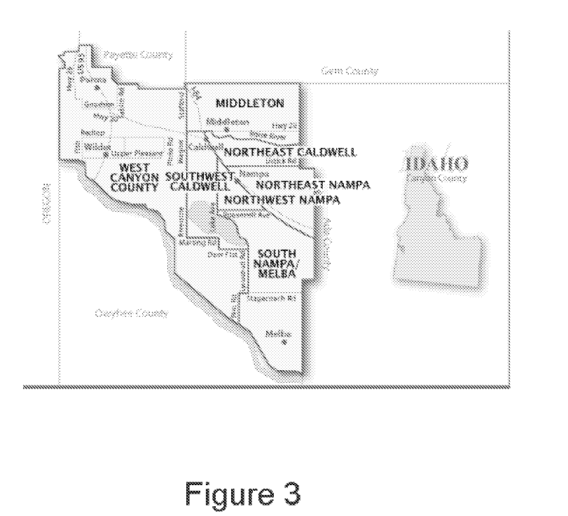

The system 1 will allow the Broker marketing agents of other companies. The system 1 will have marketing subdivisions within the web site, such as newyorkrealestatereview.com/subdivision. Each subdivisions gets a different page: floridarealestatereview.com/fortlauderdale, or georgiarealestatereview.com/fulton, etc. FIG. 3 displays a marketing subdivision shown in map form. The system 1 will display property information on and off of a map. The system 1 may have videos displayed about each area.

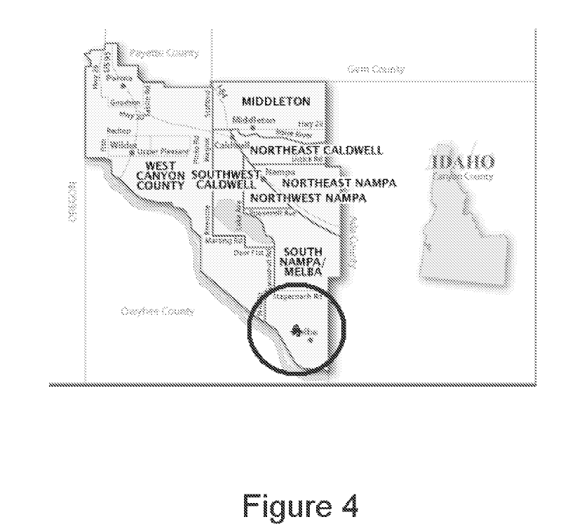

The system 1 will allow marketing companies targets to specific region. Example: a company (such as a restaurant) located in the South East area of Boise, Id. will be allowed to market there company specific to pages which relate to South East Boise. Property pages, video pages, agent pages etc. Banner ads and other web ads can be marketed for a specific area, zip code or radius of a certain house that's for sale. This is shown in FIG. 4.

Once qualified, agents 10 maintain their own site content on the system 1 by logging in. The agent 10 would maintain a weekly ad on the system 1 such as those in the news paper with new listings and lyrics about themselves.

The system 1 would allow document exchanges between parties, with or without electronic signatures. The system 1 would be set up to allow electronic signature that would allow a buyer or seller to sign a document online, eliminating the need to print.

The system 1 can be used by buyers 20 and sellers 30 to gather information about real estate, listed properties, agent insight, and area statistics as well as lenders, escrow agent's registration available.

The system 1 has sources of supply of information.

The Agents 10 supply “Insight” about the country, state, county, city or area of which they have qualified and registered. This information is used to inform potential buyers and sellers about the area of their specialty.

MLS information is supplied through an agreement between the MLS system in the area (example: intermountain MLS, Rapitoni, etc.). This information is provided through a data feed such as a “Real Estate Transaction Standard” (R.E.T.S.), or an FTP feed. In order to maintain access to said information, a real estate broker/agent 10 must meet all requirements of the membership through said MLS provider. Some examples of requirements for MLS access: Maintain an active license in good standing with the real estate commission in said area. Pay all fees associated with said memberships: MLS, National Association of Realtors (NAR), state real estate commission, as well as any continuing education requirements.

The system 1 will use Statistical reports generated from MLS data consisting of current average prices for a country, state, county, city or area. Statistical reports also generated by periods, such as month, year, etc. These reports are displayed on the website and are current with the most recent data update (daily, hourly etc.). Statistics could include average sale price, average price per square foot etc., for the previous month, previous 3 months, previous 6 months, etc. These reports will be separated by country, state, county, city, and/or area.

Information will be provided to the system by outside analysis, such as news articles or news letters.

The system 1 will also allow Buyers 20 and sellers 30 to participate in blogs. Blogs are used to discuss topics of interest. Blogs are used to discuss schools, traffic, restaurants etc.

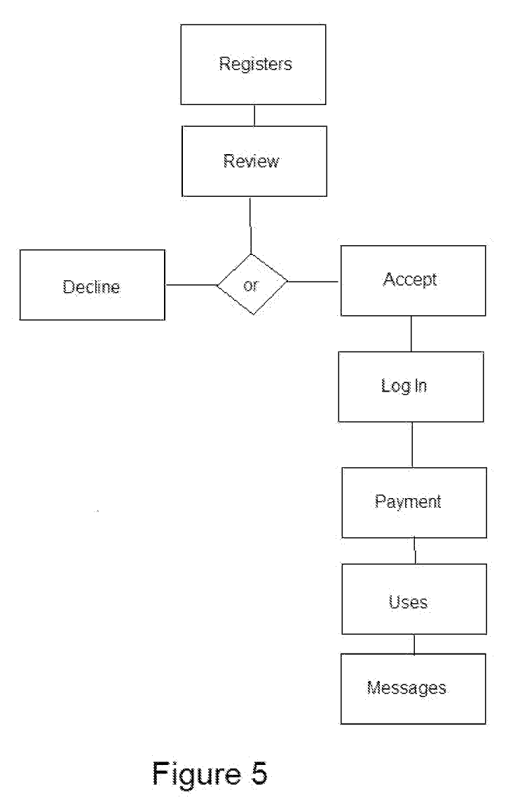

FIG. 5 displays the agents sign on process. It is as follows: 1. Agent 10 Registers using their name, company name, phone number, MLS ID #, e-mail address. Agent 10 selects areas where listed benchmarks have been met and sales numbers in each qualifying area. 2. The system 1 reviews registration against benchmark requirements. Example Benchmarks: 3 consecutive years with sales in the registered area, 1% of total sales for the area for the previous year. 3. If the Agent's Sales<1%, w/o 3 years sales then the system 1 will Decline. Send automatic e-mail declining registration. If the Agent's Sales>1%, w/3 years sales then the system 1 will accept and send agent link to register and a Link to e-mail address used to register. 4. The Agent 10 logs in, sets up and maintains an account with Pictures, insight about the area etc. 5. Agent 10 submits payment (billed monthly, quarterly, 6 months, yearly or through a compensation agreement as a percentage of the commission from the sale of homes through leads generated from the site), and the agent's account is activated. 6. Agent 10 uses account to interact with customers through a messaging system (which can include automatic emails sent to an account outside of the system). 7. Messages can include attachments which can be sent and received. Documents may also be signed electronically with e-signatures, eliminating the need to print.

The benchmarks for registering Agents 10 can also be years of service and amount of previous years sales.

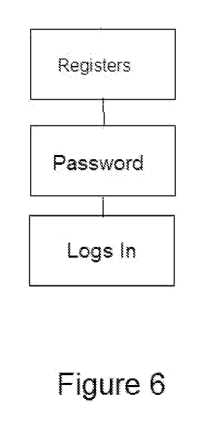

FIG. 6 displays the buyers 20 and sellers 30 registration process in the preferred embodiment. 1. Non agent (user) registers using their name, phone number, email address etc. 2. User receives an email with a link to create a password and login. 3. User logs into their account to use the following features: Saved search criteria, automatic email notifications to the email address used to register with, save property favorites, send and receive messages, messages can include documents from agents and may be signed using electronic signatures.

### Advantages

There are numerous advantages to the system 1 and process. On is the cost as it is free for consumers to use, no registration required to view listings and content. Speed: Listings updated with the most accurate information available (information varies by MLS, and highest quality is reserved for Brokers only). Ease of use: Content will be very easy to use. MLS information will be combined from multiple MLS systems and will be developed in such a way which will make it consistent and comparable. Novelty: None of the previous known counterparts are acting as a licensed real estate broker, marketing top agents from other companies (brokerages). Convenience/Social Benefit/Mechanization: This method makes life easier for buyers and sellers by providing the most accurate content possible, as well as current information from top agents in any area which that buyer or seller is interested in. Salability: This method is easier to sell because it's being marketed by a neutral third party broker. Customers have their choice of agents from any company, as long as said agent meets or exceeds the sales benchmark. Precision: Content on the site is far more precise that previous counterparts because of the direct data feed from the MLS, also because registered agents may update content about the areas they are registered in at any time, 24/7. Market Size: Market size is unlimited. As long as said third party broker maintains access to the MLS in that market area. It provides the Trend of Demand from the Site Source.

Thousands of real estate web sites currently exist, and consumers are currently searching for real estate for an average of 9 weeks. This site will have an easy time penetrating the market.

The system 1 will give the agents 10 using it a competitive advantage. Miscellaneous/Obviation of Specific Disadvantages of Existing Devices: With real estate brokerages in any city being in competition, it's virtually impossible for one brokerage to maintain the licenses of all top agents in the area, and no company can do that repetitively. Thus, making it impossible for anyone other than a licensed neutral third party real estate broker to market verified top agents from all companies on one web site.

The system 1, method and process will have a Long Life Cycle: As long as there are MLS systems, and licensed real estate brokers with access to those MLS systems, this method will be useful to both agents and consumers.

The system 1 satisfies existing need: 3 out of 4 real estate buyers begin their home search online. Currently, top real estate agents have no way to verify their experience level to large markets of buyers and sellers. Young people are more likely to use the internet, making this method more likely to be used for future generations. High sales are anticipated.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A real estate system comprising: a website that provides information to buyers and seller where the agents listed must meet a specific benchmark.

2. A system according to claim 1 where said benchmark is based on the agents previous sales.

3. A system according to claim 1 where said benchmark is based on the agent's years of service.

4. A system according to claim 1 where said benchmark is based on the agent's percentage of sales in a given area.

5. A system according to claim 1 where said system will be accessed through a website.

6. A system according to claim 5 where each agent will have a plurality of webpages on said website.

7. A system according to claim 1 where said agent will have information on said system.

8. A system according to claim 1 where said system will have access to the MLS data.

9. A system according to claim 1 where said system will be organized on marketing geographical subdivisions.

10. A system according to claim 1 where MLS information is provided to the system using a data feed.

11. A system according to claim 10 where said agent must meet all the requirements to receive said MLS information.

12. A system according to claim 1 where said system has a login procedure.

13. A system according to claim 1 where said agent registers and said system determines if the agent meets the benchmarks of the system, if the agent does the system registers the agent, if the agent does not the system declines the agent.

14. A system according to claim 1 where said a buyer or seller registers to create an account.

15. A system according to claim 1 where said system offers a saved search criteria, automatic email notifications to the email address used to register with, save property favorites, send and receive messages.

16. A system according to claim 1 where said system allows for the transferring of documents.

17. A system according to claim 16 where a user can submit an electronic signature.

18. A system according to claim 1 where said system will have BLOGs.

19. A system according to claim 1 where said system will have advertisement.

20. A system according to claim 19 where said advertisement is based on a geographical location.
